(19) United States
(12) Patent Application Publication
(10) Pub. No.: US 2026/0285693 A1
(43) Pub. Date: Sep. 24, 2026

(54) SILICON-CARBON COMPOSITE MATERIAL, PREPARATION METHOD THEREFOR, AND APPLICATION THEREOF

(71) Applicant: Ningde Amperex Technology Limited, Ningde (CN)

(72) Inventor: Yang LI, Ningde (CN)

(73) Assignee: Ningde Amperex Technology Limited, Ningde (CN)

(21) Appl. No.: 19/570,282

(22) Filed: Mar. 18, 2026

(30) Foreign Application Priority Data
Mar. 19, 2025 (CN) 202510329291.7

(51) Int. Cl. C01B 33/027; H01M 4/02; H01M 4/38; H01M 4/583; H01M 10/0525; H01M 10/0569

(52) U.S. Cl. CPC C01B 33/027; H01M 4/386; H01M 4/583; H01M 10/0525; H01M 10/0569; C01P 2002/08; C01P 2002/82; C01P 2004/64; C01P 2006/14; C01P 2006/16; C01P 2006/40; H01M 2004/021; H01M 2004/027; H01M 2300/0034

(57) ABSTRACT

A silicon-carbon composite material includes a carbon matrix and nano-silicon particles, where the nano-silicon particles are located within pores of the carbon matrix, and a Raman spectrum of the silicon-carbon composite material satisfies I_{A}≥1.2I_{B}, where I_{A} is a peak intensity of the Raman spectrum of the silicon-carbon composite material at 520 cm⁻¹±5 cm⁻¹, and I_{B} is a peak intensity of the Raman spectrum of the silicon-carbon composite material at 480 cm⁻¹±5 cm⁻¹.

### CROSS-REFERENCE TO RELATED APPLICATION

The present application claims priority to Chinese Patent Application No. 202510329291.7, filed in the China National Intellectual Property Administration on Mar. 19, 2025, the entire content of which is hereby incorporated by reference.

### TECHNICAL FIELD

This application relates to the field of electrochemical energy storage, and in particular to, a silicon-carbon composite material, a preparation method for the silicon-carbon composite material, a secondary battery using the silicon-carbon composite material, and an electronic apparatus using the secondary battery.

### BACKGROUND

With ultra-high energy density, long cycle life, and low self-discharge, lithium-ion batteries have been widely used in vehicles, consumer electronics, and large-scale energy storage. In recent years, silicon-based materials are known for high specific capacities (Li₁₅Si₄, 3579 mAh g⁻¹), abundant resource reserves, and reasonable lithiation platform (<0.4 V vs. Li/Li⁺), and have been gradually commercialized as the negative electrode for lithium-ion batteries, and considered the most promising next-generation negative electrode material.

Although silicon-based materials have the foregoing advantages, silicon-based active materials tend to react with water, generating gas during anode slurry preparation. This easily causes bubbles on the surface of a prepared negative electrode plate and reduces the specific capacity of the active material.

### SUMMARY

This application provides a silicon-carbon composite material, a preparation method therefor, and application thereof.

A first aspect of this application provides a silicon-carbon composite material, including a carbon matrix and nano-silicon particles, where the nano-silicon particles are located within pores of the carbon matrix, and a Raman spectrum of the silicon-carbon composite material satisfies I_{A}≥1.2I_{B}, where I_{A} is a peak intensity of the Raman spectrum of the silicon-carbon composite material at 520 cm⁻¹±5 cm⁻¹, and I_{B} is a peak intensity of the Raman spectrum of the silicon-carbon composite material at 480 cm⁻¹±5 cm⁻¹.

For the silicon-carbon composite material of this application, peak A represents the photon-phonon vibration peak of crystalline silicon, and a higher I_{A} peak intensity indicates a higher proportion of crystalline silicon. Peak B represents the Si—Si stretching vibration peak of amorphous silicon, and a higher I_{B} peak intensity indicates a higher proportion of amorphous silicon. The inventors have found that the value of I_{A}/I_{B} within a specified range can reflect the crystallinity (a ratio of the Raman peak intensity of the crystalline silicon region to that of the amorphous silicon region in the silicon-carbon composite material) of a silicon domain, where the silicon domain is formed by crystalline silicon and amorphous silicon in the silicon-carbon composite material. When I_{A} and I_{B} satisfy the foregoing relational expression, the proportions of crystalline silicon and amorphous silicon in the silicon-carbon composite material can be controlled within appropriate ranges, helping reduce the amount of amorphous silicon in the silicon-carbon composite material. The main component of amorphous silicon is silicon hydride, which is more prone to react with water due to the absence of an ordered lattice. Therefore, controlling the value of I_{A}/I_{B} can suppress the reaction of silicon hydride with water, thereby reducing gas generation and silicon consumption during anode slurry preparation. This helps increase the capacity contribution of silicon in the silicon-carbon composite material and increase the specific capacity of the silicon-carbon composite material.

According to the first aspect, in some possible embodiments, 5.3I_{B}≥I_{A}≥2.4I_{B}. Compared with crystalline silicon, amorphous silicon has more defect pores inside, helping mitigate the swelling of the silicon-carbon composite material and improve the cycling performance of the secondary battery. When 5.3I_{B}≥I_{A}≥2.4I_{B} holds, the proportion of crystalline silicon in the silicon domain of the silicon-carbon composite material can be further increased, and the ordered lattice of crystalline silicon reduces the reactivity with water, thereby reducing gas generation during anode slurry preparation. In addition, this helps mitigate the swelling of the silicon-carbon composite material and improve the cycling performance of the secondary battery.

According to the first aspect, in some possible embodiments, the silicon-carbon composite material and an aqueous potassium hydroxide solution are mixed to obtain a mixture, and the mixture is held at T1 for 6 hours and then subjected to an alkali solubility test, where 53° C.≥T1≥47° C., the measured alkali solubility of the silicon-carbon composite material is α and α≤20%, a concentration of the aqueous potassium hydroxide solution is 1.78 mol/L, and a mass ratio of potassium hydroxide to the silicon-carbon composite material in the mixture is 4:1. The alkali solubility can reflect the decomposition reaction energy barrier of silicon in the silicon-carbon composite material. In this application, controlling the alkali solubility of the silicon-carbon composite material within an appropriate range helps make the silicon-carbon composite material inert to some extent, so that the reaction of silicon with water in the silicon-carbon composite material has a higher decomposition reaction energy barrier. In this case, when the value of I_{A}/I_{B} of the silicon-carbon composite material satisfies a relational expression, less gas is generated during anode slurry preparation, and the specific capacity of the silicon-carbon composite material is increased.

According to the first aspect, in some possible embodiments, 0.1%<α<15%. This helps further reduce gas generation during anode slurry preparation and increase the specific capacity of the silicon-carbon composite material.

According to the first aspect, in some possible embodiments, at T2, the silicon-carbon composite material and water are mixed at a mass ratio of 1:8 to obtain a dispersion system, where 27° C.≥T2≥23° C., the dispersion system is sealed and left standing for 48 hours, and then gas generated by the dispersion system is tested, where based on a total volume of the generated gas, a volume percentage of H₂ is less than 3%. When the volume percentage of H₂ in the dispersion system is within that range, silicon in the silicon-carbon composite material presents greater inertness, helping suppress the reaction of the silicon-carbon composite material with water and reduce gas generation during anode slurry preparation.

According to the first aspect, in some possible embodiments, based on the total volume of the generated gas, the volume percentage of H₂ is greater than 0.1% and less than 3%. Controlling H₂ within this range enhances the inertness of silicon in the silicon-carbon composite material, helping further suppress the reaction of the silicon-carbon composite material with water, reducing gas generation during anode slurry preparation, and increasing the specific capacity of the silicon-carbon composite material.

According to the first aspect, in some possible embodiments, the nano-silicon particles include silicon grains, and an average diameter of the silicon grains is 3 nm to 8 nm. When the average grain size of silicon is within this range, it indicates a high proportion of crystalline silicon in the silicon domain. In this case, a crystalline silicon-based silicon domain is formed, helping increase the decomposition reaction energy barrier for the reaction of silicon with water in the silicon-carbon composite material. This further reduces gas generation during anode slurry preparation and increases the specific capacity of the silicon-carbon composite material.

According to the first aspect, in some possible embodiments, the average diameter of the silicon grains is 3 nm to 6 nm. This helps further increase the proportion of crystalline silicon in the silicon domain, reduce gas generation during anode slurry preparation, and increase the specific capacity of the silicon-carbon composite material.

According to the first aspect, in some possible embodiments, the silicon-carbon composite material contains silicon element, and based on mass of the silicon-carbon composite material, a mass percentage of the silicon element is 42% to 50%. This helps ensure a high specific capacity and energy density of the silicon-carbon composite material while minimizing the proportion of silicon element, thereby reducing contact between the silicon-carbon composite material and water and reducing gas generation during anode slurry preparation.

A second aspect of this application provides a preparation method for a silicon-carbon composite material. The method includes: introducing a silane gas mixture into a carbon matrix and holding at 400° C. to 480° C. for 2 hours to 30 hours to obtain a first intermediate, where the silane gas mixture includes a silane gas and an inert gas; in an inert gas atmosphere, heat-treating the first intermediate at 650° C. to 750° C. for 1 hour to 6 hours to obtain a second intermediate; and at a temperature of 25° C. to 200° C., introducing oxygen into the second intermediate to obtain the silicon-carbon composite material.

In the preparation method provided by this application, through heat-treatment of the first intermediate, amorphous silicon in the first intermediate is dehydrogenated to form crystalline silicon, increasing the proportion of crystalline silicon in a silicon domain, reducing the proportion of amorphous silicon in the silicon-carbon composite material, suppressing the reaction of the silicon-carbon composite material with water, and reducing gas generation and silicon consumption during anode slurry preparation. This helps increase the capacity contribution of silicon in the silicon-carbon composite material and increase the specific capacity of the silicon-carbon composite material.

According to the second aspect, in some possible embodiments, the carbon matrix has mesopores, the mesopore refers to a pore with a pore size of 2 nm to 10 nm, and based on a sum of pore volumes of pores with a pore size of 0.5 nm to 10 nm, a pore volume percentage of the mesopores is 40% to 70%. Controlling the pore volume percentage of mesopores within this range helps improve the resistance of the carbon matrix to high-temperature calcination. When the pore volume and pore size of mesopores are within the specified ranges, silicon can be easily formed into crystalline silicon with a large particle size. This helps form a crystalline silicon-based silicon-carbon composite material, reduce silicon carbide generated during heating at high temperatures, and enhance the specific capacity and first-cycle Coulombic efficiency of the silicon-carbon composite material.

A third aspect of this application provides a secondary battery, including a positive electrode plate, a separator, and a negative electrode plate, where the negative electrode plate includes a negative electrode current collector and a negative electrode material layer located on at least one surface of the negative electrode current collector, the negative electrode material layer includes a negative electrode active material, and the negative electrode active material includes graphite, where the negative electrode active material further includes a silicon-carbon composite material, and based on mass of the negative electrode active material, a mass percentage of the silicon-carbon composite material is 5% to 30%. When the mass percentage of the silicon-carbon composite material is controlled within this range, the interface of the silicon-carbon composite material is protected to a certain extent due to high surface stability of graphite, thereby reducing the formation of excessive SEI film and enhancing the specific capacity and cycling performance of the secondary battery.

According to the third aspect, in some possible embodiments, the electrolyte contains fluoroethylene carbonate, and based on mass of the electrolyte, a mass percentage of fluoroethylene carbonate is 11.5% to 19.5%. Including the foregoing electrolyte in the secondary battery can further stabilize the solid electrolyte interface film on the surface of the silicon-carbon composite material, helping improve the high-temperature cycling performance of the secondary battery.

A fourth aspect of this application provides an electronic apparatus, including a secondary battery, where the secondary battery supplies power to the electronic apparatus. With high specific capacity and cycling performance, the secondary battery helps improve the cycling performance and service life of the electronic apparatus.

### DETAILED DESCRIPTION OF EMBODIMENTS

The following clearly and detailed describes the technical solutions in the embodiments of this application. Apparently, the described embodiments are only some rather than all of the embodiments of this application. Unless otherwise defined, all technical and scientific terms used herein shall have the same meanings as commonly understood by those skilled in the art to which this application belongs. The terms used herein in the specification of this application are only used to describe specific embodiments, and are not intended to limit this application.

In the related art, severe volume changes of silicon-based materials during lithiation/delithiation lead to low cycling performance, as well as electrode pulverization and failure, which hinders the full play of the electrochemical performance of silicon-based materials. To solve this problem, researchers have found that nanonization of silicon-based materials, forming composite materials with other substances, and changing the battery matching system can alleviate structural strain, shorten lithium-ion diffusion distance, and facilitate effective electrochemical contact of active substances.

Featuring excellent electrical conductivity and strength, the carbon material is considered one of the best composite materials for compounding with silicon. Silicon-carbon composite materials have been widely studied and developed, but some problems still exist. For example, during anode slurry preparation, silicon-carbon materials are likely to react with water under the condition of high-speed stirring to produce hydrogen gas according to the following reaction, causing problems such as gas generation in the slurry, bubbles appearing on the electrode plate, and specific capacity loss of the active substance.

$$↑ Si + 2 {H}_{2} O = {SiO}_{2} + 2 {H}_{2} ↑$$

Therefore, how to improve the aqueous stability of silicon-carbon materials to ensure proper electrode manufacturing is still a problem that needs to be solved.

In view of this problem, this application provides a silicon-carbon composite material and a preparation method therefor, a secondary battery, and an electronic apparatus.

An embodiment of this application provides a secondary battery, including a housing, an electrode assembly, and an electrolyte. Both the electrode assembly and the electrolyte are located within the housing.

The housing may be a packaging bag obtained by packaging with a packaging film (such as an aluminum-plastic film). For example, the secondary battery is a pouch battery. In some other embodiments, the secondary battery may alternatively be a steel-shell battery, an aluminum-shell battery, or the like.

The electrode assembly includes a positive electrode plate, a negative electrode plate, and a separator, with the separator disposed between the positive electrode plate and the negative electrode plate. The electrode assembly may be a laminated structure formed by alternately stacking the positive electrode plate, the separator, and the negative electrode plate. In some other embodiments, the electrode assembly may alternatively be a wound structure formed by stacking and then winding the positive electrode plate, the separator, and the negative electrode plate.

### Negative Electrode Plate

The negative electrode plate includes a negative electrode current collector and a negative electrode material layer provided on at least one surface of the negative electrode current collector. The negative electrode current collector may be at least one of copper foil, nickel foil, stainless steel foil, titanium foil, or carbon-based current collector, or may be any composite current collector disclosed in the prior art, for example, including but not limited to a current collector formed by combining the foregoing conductive foil with a polymer substrate. The negative electrode material layer includes a negative electrode active material, and the negative electrode active material includes a silicon-carbon composite material.

The silicon-carbon composite material includes a carbon matrix and nano-silicon particles, where the nano-silicon particles are located within pores of the carbon matrix, and a Raman spectrum of the silicon-carbon composite material satisfies I_{A}≥1.2I_{B}, where I_{A} is a peak intensity of the Raman spectrum of the silicon-carbon composite material at 520 cm⁻¹±5 cm⁻¹, and I_{B} is a peak intensity of the Raman spectrum of the silicon-carbon composite material at 480 cm⁻¹±5 cm⁻¹.

In this application, peak A is the peak of the Raman spectrum of the silicon-carbon composite material at 520 cm⁻¹±5 cm⁻¹, and peak B is the peak of the Raman spectrum of the silicon-carbon composite material at 480 cm⁻¹±5 cm⁻¹. Peak A represents the photon-phonon vibration peak of crystalline silicon, and a higher I_{A} peak intensity indicates a higher proportion of crystalline silicon. Peak B represents the Si—Si stretching vibration peak of amorphous silicon, and a higher I_{B} peak intensity indicates a higher proportion of amorphous silicon. The inventors have found that the value of I_{A}/I_{B} within a specified range can reflect the crystallinity (a ratio of the Raman peak intensity of the crystalline region to that of the amorphous silicon region in the silicon-carbon composite material) of a silicon domain, where the silicon domain is formed by crystalline silicon and amorphous silicon in the silicon-carbon composite material. When I_{A} and I_{B} satisfy the foregoing relational expression, the proportions of crystalline silicon and amorphous silicon in the silicon-carbon composite material can be controlled within appropriate ranges, helping reduce the amount of amorphous silicon in the silicon-carbon composite material. The main component of amorphous silicon is silicon hydride, which is more prone to react with water due to the absence of an ordered lattice. Controlling the value of I_{A}/I_{B} can suppress the reaction of silicon hydride with water, thereby reducing gas generation and silicon consumption during anode slurry preparation. This helps increase the capacity contribution of nano-silicon particles in the silicon-carbon composite material and increase the specific capacity of the silicon-carbon composite material.

If I_{A}<1.2I_{B}, amorphous silicon accounts for a larger proportion in the silicon-carbon composite material, and there will be pores (for example, about 0.5 nm pores) in the amorphous silicon region. The silicon hydride in amorphous silicon has high reactivity with water and is more prone to react with water, increasing gas generation during anode slurry preparation and reducing the specific capacity of the silicon-carbon composite material. In some embodiments, the value of I_{A}/I_{B} may be 1.2, 1.3, 1.4, 1.5, 1.6, 1.7, 1.8, 2, 2.1, 2.2, 2.4, 2.5, 2.8, 3, 3.5, 3.8, 4, 4.2, 4.5, 4.8, 5, 5.2, 5.3, or any value within a range defined by any two of these values.

In some embodiments, 5.3I_{B}≥I_{A}≥2.4I_{B}. Compared with crystalline silicon, amorphous silicon has more defect pores inside, helping mitigate the swelling of the silicon-carbon composite material and improve the cycling performance of the secondary battery. When the relationship between I_{A} and I_{B} matches this range, it helps further increase the proportion of crystalline silicon in the silicon domain, and the ordered lattice of crystalline silicon reduces the reactivity with water, thereby reducing gas generation during anode slurry preparation and further increasing the specific capacity of the silicon-carbon composite material. In addition, this helps mitigate the swelling of the silicon-carbon composite material and improve the cycling performance of the secondary battery.

In some embodiments, the silicon-carbon composite material and an aqueous potassium hydroxide solution are mixed to obtain a mixture, and the mixture is held at T1 for 6 hours and then subjected to an alkali solubility test, where 53° C.≥T1≥47° C., the measured alkali solubility of the silicon-carbon composite material is α and α≤20%, a concentration of the aqueous potassium hydroxide solution is 1.78 mol/L, and a mass ratio of potassium hydroxide to the silicon-carbon composite material in the mixture is 4:1.

The alkali solubility can reflect the decomposition reaction energy barrier of nano-silicon particles in the silicon-carbon composite material, as shown in the following chemical reaction formula:

$$Si + {H}_{2} O + 2 K O H = {K}_{2} S i {O}_{3} + 2 {H}_{2} ↑$$

In this chemical reaction formula, if the alkali solubility of the silicon-carbon composite material is excessively high, it indicates a low energy barrier for the reaction of the silicon-carbon composite material with water; if the alkali solubility of the silicon-carbon composite material is excessively low, it indicates a high energy barrier for the reaction of the silicon-carbon composite material with water. The alkali solubility can reflect the degree of inertness of the silicon-carbon composite material with respect to reaction with water. A lower alkali solubility makes the silicon-carbon composite material inert to reaction with water, thereby helping reduce gas generation during anode slurry preparation and increase the specific capacity of the silicon-carbon composite material. In this application, controlling the alkali solubility of the silicon-carbon composite material within an appropriate range helps make the silicon-carbon composite material inert to some extent, so that the reaction of silicon with water in the silicon-carbon composite material has a higher decomposition reaction energy barrier. In this case, when the value of I_{A}/I_{B} of the silicon-carbon composite material satisfies a relational expression, gas generation during anode slurry preparation can be further reduced, increasing the specific capacity of the silicon-carbon composite material.

In some embodiments, the alkali solubility of the silicon-carbon composite material may be 0.05%, 0.1%, 0.3%, 0.5%, 1%, 2%, 3%, 4%, 5%, 7%, 9%, 11%, 13%, 14%, 15%, 16%, 17%, 18%, 19%, 20%, or any value within a range defined by any two of these values. In some embodiments, T1 may be 47° C., 48° C., 49° C., 50° C., 51° C., 52° C., 53° C., or any value within a range defined by any two of these values.

In some embodiments, 0.1%≤α≤15%. When the alkali solubility of the silicon-carbon composite material is within this range, nano-silicon particles are inert towards water in reaction. This helps further reduce gas generation during anode slurry preparation and increase the specific capacity of the silicon-carbon composite material.

In some embodiments, at T2° C., the silicon-carbon composite material and water are mixed at a mass ratio of 1:8 to obtain a dispersion system, where 27° C.≥T2≥23° C., the dispersion system is sealed and left standing for 48 hours, and then gas generated by the dispersion system is tested, where based on a total volume of the generated gas, a volume percentage of H₂ is less than 3%. In this application, the reaction energy barrier between nano-silicon particles and water can be further reflected by controlling the volume percentage of H₂ in the gas generation test of the dispersion system. In the dispersion system formed by combining the silicon-carbon composite material with water at the foregoing mass ratio, when the volume percentage of H₂ is within that range, silicon in the silicon-carbon composite material has greater inertness, helping suppress the reaction of the silicon-carbon composite material with water and reduce gas generation during anode slurry preparation. When the volume percentage of H₂ is larger, silicon-carbon composite material and water exhibit a higher degree of reaction, which is not conducive to reducing gas generation during anode slurry preparation or increasing the specific capacity of the silicon-carbon composite material. In some embodiments, the volume percentage of H₂ may be 0.05%, 0.1%, 0.2%, 0.3%, 0.4%, 0.5%, 1%, 1.5%, 2%, 2.2%, 2.5%, 2.9%, or any value within a range defined by any two of these values. In some embodiments, T2 may be 23° C., 24° C., 25° C., 26° C., 27° C., or any value within a range defined by any two of these values. In some embodiments, during a test of the gas generated by the dispersion system, the volume percentage of H₂ is greater than 0.1% and less than 3% based on the total volume of the generated gas. Controlling H₂ within this range enhances the inertness of silicon in the silicon-carbon composite material, helping further suppress the reaction of the silicon-carbon composite material with water, reducing gas generation during anode slurry preparation, and increasing the specific capacity of the silicon-carbon composite material.

In some embodiments, the nano-silicon particles include silicon grains, and an average diameter of the silicon grains is 3 nm to 8 nm. The average diameter of the nano-silicon particles can be measured by X-ray diffraction and calculated. The measured average diameter of the silicon grains is specifically the average grain size of crystalline silicon. The average diameter of the silicon grains can reflect the distribution of crystalline silicon in a silicon domain. When the average diameter of the silicon grains is within that range, it indicates a high proportion of crystalline silicon in the silicon domain. In this case, a crystalline silicon-based silicon domain is formed, helping increase the decomposition reaction energy barrier for the reaction of silicon with water in the silicon-carbon composite material. This further reduces gas generation during anode slurry preparation and increase the specific capacity of the silicon-carbon composite material. If the average diameter of the silicon grains is small, for example, less than 3 nm, it indicates a high proportion of amorphous silicon in the silicon domain, and amorphous silicon are likely to react with water, which is not conducive to reducing gas generation during anode slurry preparation or increasing the specific capacity of the silicon-carbon composite material. If the average grain diameter of the nano-silicon particles is great, for example, greater than 8 nm, crystalline Li₁₅Si₄ is generated at the end of lithiation of the silicon-carbon composite material, affecting the cycling stability of the secondary battery. In some embodiments, the average grain diameter of nano-silicon particles in the silicon-carbon composite material may be 3 nm, 3.5 nm, 4 nm, 4.5 nm, 5 nm, 5.5 nm, 6 nm, 6.5 nm, 7 nm, 7.5 nm, 8 nm, or any value within a range defined by any two of these values.

In some embodiments, the average diameter of the silicon grains is 3 nm to 6 nm. When the average diameter of the silicon grains is within this range, the proportion of crystalline silicon in the silicon domain can be further increased, further reducing gas generation during anode slurry preparation and increasing the specific capacity of the silicon-carbon composite material.

In some embodiments, the silicon-carbon composite material contains silicon element, and based on mass of the silicon-carbon composite material, a mass percentage of the silicon element is 42% to 50%. Controlling the mass percentage of the silicon element within the above range helps ensure a high specific capacity and energy density of the silicon-carbon composite material while minimizing the proportion of silicon element, thereby reducing contact between the silicon-carbon composite material and water and reducing gas generation during anode slurry preparation. In some embodiments, based on the mass of the silicon-carbon composite material, the mass percentage of the silicon element may be 42%, 43%, 44%, 45%, 46%, 47%, 48%, 49%, 50%, or any value within a range defined by any two of these values.

In some embodiments, the silicon-carbon composite material further contains carbon element and oxygen element, and based on the mass of the silicon-carbon composite material, a mass percentage of carbon element is 45% to 57%, and a mass percentage of oxygen element is 1% to 5%. In the silicon-carbon composite material, controlling the mass percentage of carbon element within the specified range helps reduce contact between silicon and water, reduce gas generation during anode slurry preparation, and increase the specific capacity of the silicon-carbon composite material.

Controlling the mass percentage of oxygen element within the specified range helps improve the stability of the silicon-carbon composite material and enhance cycling stability. In some embodiments, based on the mass of the silicon-carbon composite material, the mass percentage of carbon element may be 45%, 48%, 50%, 52%, 54%, 56%, 57%, or any value within a range defined by any two of these values. The mass percentage of oxygen element may be 1%, 2%, 3%, 4%, 5%, or any value within a range defined by any two of these values.

This application further provides a preparation method for a silicon-carbon composite material, including the following steps.

Step S1. Introduce a silane gas mixture into a carbon matrix to deposit and form nano-silicon particles in the carbon matrix, to obtain a first intermediate, where the silane gas mixture includes a silane gas and an inert gas.

Through chemical vapor deposition, the silane gas mixture deposits as nano-silicon particles within pores of the carbon matrix. Specifically, in an inert gas atmosphere, the carbon matrix is heated to 400° C. to 480° C. at a rate of 5° C./min to 20° C./min and then the temperature is maintained. The silane gas mixture is introduced at this temperature for 2 hours to 30 hours at a flow rate of 100 sccm to 500 sccm, and silicon from the silane gas mixture is deposited in the pores and on the surface of the carbon matrix to obtain the first intermediate.

In some embodiments, the carbon matrix may be heated to and held at 400° C., 420° C., 440° C., 460° C., 480° C., or any value within a range defined by any two of these values. The heating rate may be 5° C./min, 8° C./min, 10° C./min, 15° C./min, 20° C./min, or any value within a range defined by any two of these values. The duration for introducing the silane gas mixture may be 2 hours, 4 hours, 8 hours, 10 hours, 15 hours, 20 hours, 25 hours, 30 hours, or any value within a range defined by any two of these values. The flow rate for introducing the silane gas mixture may be 100 sccm, 200 sccm, 300 sccm, 400 sccm, 500 sccm, or any value within a range defined by any two of these values.

The silane gas mixture includes a silane gas and an inert gas, and based on mass of the silane gas mixture, a mass percentage of the silane gas is 10% to 50%, and a mass percentage of the inert gas is 50% to 90%. Within this range, introducing a specified amount of inert gas into the silane gas helps improve the uniformity of silicon deposition, fully explore the silicon capacity of the silicon-carbon composite material, and increase the specific capacity of the silicon-carbon composite material. In some embodiments, based on the mass of the silane gas mixture, the mass percentage of the silane gas may be 10%, 20%, 30%, 40%, 50%, or any value within a range defined by any two of these values.

In some embodiments, the silane gas may include but is not limited to at least one of monosilane, disilane, trisilane, tetrasilane, chlorosilane, dichlorosilane, trichlorosilane, or tetrachlorosilane.

The inert gas includes at least one of nitrogen or argon.

In some embodiments, the carbon matrix has mesopores, the mesopore refers to a pore with a pore size of 2 nm to 10 nm, and based on a sum of pore volumes of pores with a pore size of 0.5 nm to 10 nm, a pore volume percentage of the mesopores is 40% to 70%. Controlling the pore volume percentage of mesopores within this range helps improve the resistance of the carbon matrix to high-temperature calcination. When the pore volume and pore size of mesopores are within the specified ranges, silicon can be easily formed into crystalline silicon with a large particle size. This helps form a crystalline silicon-based silicon-carbon composite material, reduce silicon carbide generated during heating at high temperatures, and enhance the specific capacity and first-cycle Coulombic efficiency of the silicon-carbon composite material. If the pore volume percentage of mesopores is small and that of micropores is high, more silicon carbide may be generated in the silicon-carbon composite material during high-temperature processes, reducing the specific capacity and first-cycle Coulombic efficiency of the silicon-carbon composite material. If the pore size of mesopores is small, the silicon particles within the micropores may be too small and prone to react with water, and therefore the effect of reducing gas generation during anode slurry preparation is not significant; if the pore size of mesopores is large, the deposited silicon particles have a large size, and nano-silicon particles tend to generate Li₁₅Si₄, compromising the cycling stability of the silicon-carbon composite material. In some embodiments, the pore volume percentage of mesopores in the carbon matrix may be 40%, 45%, 50%, 55%, 60%, 65%, 70%, or any value within a range defined by any two of these values.

Step S2. In an inert gas atmosphere, heat-treat the first intermediate at 650° C. to 750° C. for 1 hour to 6 hours to obtain a second intermediate.

The inert gas includes at least one of nitrogen or argon.

Another heating and crystallization of the first intermediate at 650° C. to 750° C. helps dehydrogenate amorphous silicon in the first intermediate to form crystalline silicon, increasing the proportion of crystalline silicon in the silicon domain.

The duration of heat treatment for crystallization of the first intermediate is 1 hour to 6 hours, which helps obtain silicon grains with their average diameter falling within a specified range, so that the average diameter of silicon grains in the nano-silicon particles of the first intermediate is adjusted. In some embodiments, the heat treatment temperature of the first intermediate may be 650° C., 670° C., 690° C., 710° C., 720° C., 740° C., 750° C., or any value within a range defined by any two of these values. The heat treatment duration of the first intermediate may be 1 hour, 2 hours, 3 hours, 4 hours, 5 hours, 6 hours, or any value within a range defined by any two of these values.

Step S3. Lower the heat treatment temperature in step S2 to 25° C. to 200° C. and introduce oxygen into the second intermediate to obtain the silicon-carbon composite material.

In some embodiments, a mixture of an inert gas and oxygen is introduced into the second intermediate, and oxygen reacts with silicon on the surface of the second intermediate to form silicon oxide, thereby passivating the surface of the second intermediate. In the oxygen mixture formed by the inert gas and oxygen, based on mass of the oxygen mixture, a mass percentage of oxygen is 2% to 20%, and a mass percentage of the inert gas (such as nitrogen) is 80% to 98%. With the proportions of oxygen and inert gas controlled within these ranges, the oxygen mixture can uniformly passivate the surface of the second intermediate, stabilizing the surface of the second intermediate. In some embodiments, the mass percentage of oxygen may be 2%, 5%, 8%, 10%, 13%, 15%, 20%, or any value within a range defined by any two of these values.

In some embodiments, the reaction temperature in step S3 may be 25° C., 50° C., 75° C., 100° C., 125° C., 150° C., 175° C., 200° C., or any value within a range defined by any two of these values.

In some embodiments, the reaction duration for oxygen passivation of the second intermediate in step S3 is 1 hour to 6 hours, and the flow rate of the introduced oxygen mixture is 100 sccm to 500 sccm, so that the oxygen mixture fully reacts with the surface of the second intermediate. The reaction duration may be 1 hour, 2 hours, 3 hours, 4 hours, 5 hours, 6 hours, or any value within a range defined by any two of these values. The flow rate of the introduced oxygen mixture may be 100 sccm, 200 sccm, 300 sccm, 400 sccm, 500 sccm, or any value within a range defined by any two of these values.

In the preparation method for the silicon-carbon composite material provided by this application, through heat-treatment of the first intermediate, amorphous silicon in the first intermediate is dehydrogenated to form crystalline silicon, increasing the proportion of crystalline silicon in the silicon domain, reducing the proportion of amorphous silicon in the silicon-carbon composite material, suppressing the reaction of the silicon-carbon composite material with water, and reducing gas generation and silicon consumption during anode slurry preparation. This helps increase the capacity contribution of silicon in the silicon-carbon composite material and increase the specific capacity of the silicon-carbon composite material.

In this application, the pore volume percentage and pore size of mesopores in the carbon matrix, as well as the pyrolysis temperature and duration for the first intermediate are adjusted. In this way, I_{A}/I_{B} in the Raman spectrum of the silicon-carbon composite material satisfies a specified relationship, the silicon-carbon composite material has an appropriate alkali solubility, the volume percentage of H₂ is within a specified range, and the average diameter of silicon grains in the nano-silicon particles is within a specified range. Based on the appropriate ranges specified in this application, when the pore volume of mesopores in the carbon matrix is less than 40% and/or the pore size of mesopores is less than 2 nm, the sizes of silicon grains in the nano-silicon particles deposited in the carbon matrix may be affected, reducing the proportion of crystalline silicon in the silicon domain. This results in a smaller value of I_{A}/I_{B}, higher alkali solubility, higher volume percentage of H₂ in the gas generated by the dispersion system, and smaller average diameter of nano-silicon particles, thereby increasing gas generation during anode slurry preparation and reducing the specific capacity of the silicon-carbon composite material. When the pore volume of mesopores in the carbon matrix is greater than 70% and/or the pore size of mesopores is greater than 10 nm, the value of I_{A}/I_{B}, alkali solubility, and volume percentage of H₂ in the gas generated by the dispersion system all decreases, and the average diameter of silicon grains increases. However, the swelling of the secondary battery during cycling becomes serious, compromising the cycling performance of the secondary battery.

Based on the appropriate ranges specified in this application, a higher pyrolysis temperature of the first intermediate results in a larger value of I_{A}/I_{B}, lower alkali solubility, lower volume percentage of H₂ in the gas generated by the dispersion system, and greater average diameter of silicon grains in the nano-silicon particles. However, a higher pyrolysis temperature will result in more silicon carbide generated in the silicon-carbon composite material, reducing the specific capacity of the silicon-carbon composite material. A lower pyrolysis temperature of the first intermediate results in a smaller value of I_{A}/I_{B}, higher alkali solubility, higher volume percentage of H₂ in the gas generated by the dispersion system, and smaller average diameter of silicon grains in the nano-silicon particles, thereby increasing gas generation during anode slurry preparation and reducing the specific capacity of the silicon-carbon composite material.

Based on the appropriate ranges specified in this application, a longer pyrolysis duration of the first intermediate results in a larger value of I_{A}/I_{B}, lower alkali solubility, lower volume percentage of H₂ in the gas generated by the dispersion system, and greater average diameter of silicon grains. However, the effect of reducing gas generation during anode slurry preparation is not significant, which is not conducive to increasing the specific capacity of the silicon-carbon composite material. When the pyrolysis duration of the first intermediate decreases, the first intermediate may react incompletely, resulting in a lower proportion of crystalline silicon in the silicon domain, smaller value of I_{A}/I_{B}, higher alkali solubility, higher volume percentage of H₂ in the gas generated by the dispersion system, and smaller average diameter of silicon grains in the nano-silicon particles, thereby increasing gas generation during anode slurry preparation and reducing the specific capacity of the silicon-carbon composite material.

In some embodiments, the negative electrode active material further includes graphite, and the graphite includes at least one of artificial graphite or natural graphite. Based on the mass of the negative electrode active material, the mass percentage of the silicon-carbon composite material is 5% to 30%, and the mass percentage of graphite is 70% to 95%. When the mass percentages of the silicon-carbon composite material and graphite are controlled within these ranges, the high surface stability of graphite is utilized to protect the interface of the silicon-carbon composite material to a certain extent, thereby reducing the formation of excessive SEI film and enhancing the specific capacity and cycling performance of the secondary battery. In addition, when both graphite and the silicon-carbon composite material are included in the negative electrode active material, their advantages can be fully combined for higher electrochemical performance. In some embodiments, the mass percentage of the silicon-carbon composite material may be 5%, 10%, 15%, 20%, 25%, 30%, or any value within a range defined by any two of these values, and the mass percentage of graphite may be 70%, 75%, 80%, 85%, 90%, 95%, or any value within a range defined by any two of these values.

The negative electrode material layer further includes a binder for binding particles of the negative electrode active material to facilitate film layer formation and increase the binding force between the negative electrode material layer and the negative electrode current collector. In some embodiments, the binder may include but is not limited to polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, or nylon.

The negative electrode material layer may further include a conductive material, and the conductive material includes but is not limited to a carbon-based material, a metal-based material, a conductive polymer, or any combination thereof. In some embodiments, the carbon-based material may include but is not limited to natural graphite, artificial graphite, carbon black, acetylene black, Ketjen black, carbon fiber, or any combination thereof. In some embodiments, the metal-based material may include but is not limited to metal powder or metal fiber, such as copper, nickel, aluminum, or silver. In some embodiments, the conductive polymer may be a polyphenylene derivative.

### Separator

There is no particular limitation on the material and shape of the separator used in the secondary battery of this application, and it may be any technology disclosed in the prior art. In some embodiments, the separator includes a polymer or an inorganic substance formed from a material stable to the electrolyte of this application.

For example, the separator may include a substrate layer and a surface treatment layer. The substrate layer is a non-woven fabric, membrane, or composite membrane having a porous structure, and a material of the substrate layer is selected from at least one of polyethylene, polypropylene, polyethylene terephthalate, or polyimide. Specifically, a polypropylene porous membrane, a polyethylene porous membrane, a polypropylene non-woven fabric, a polyethylene non-woven fabric, or a polypropylene-polyethylene-polypropylene porous composite membrane may be used.

The surface treatment layer is disposed on at least one surface of the substrate layer, and the surface treatment layer may be a polymer layer or an inorganic substance layer, or a layer formed by mixing a polymer and an inorganic substance. The inorganic substance layer includes inorganic particles and a binder. The inorganic particles are selected from at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is selected from at least one of polyvinylidene fluoride, vinylidene a fluoride-hexafluoropropylene copolymer, polyamide, polyacrylonitrile, polyacrylate, polyacrylic acid, polyacrylate salt, polyvinylpyrrolidone, polyvinyl ether, polymethyl methacrylate, polytetrafluoroethylene, or polyhexafluoropropylene. The polymer layer includes a polymer, and the material of the polymer is selected from at least one of polyamide, polyacrylonitrile, acrylate polymer, polyacrylic acid, polyacrylate salt, polyvinylpyrrolidone, polyvinyl ether, polyvinylidene fluoride, or poly(vinylidene fluoride-hexafluoropropylene).

### Electrolyte

According to some embodiments of this application, the electrolyte contains an organic solvent, a lithium salt, and an optional additive. The organic solvent in the electrolyte of this application may be any organic solvent known in the prior art that can be used as a solvent for an electrolyte. There is no limitation on the electrolytic salt used in the electrolyte of this application, and it may be any electrolytic salt known in the prior art. The additive in the electrolyte of this application may be any additive known in the prior art that can be used as an additive for the electrolyte. In some embodiments, the organic solvent includes but is not limited to ethylene carbonate (EC), propylene carbonate (PC), diethyl carbonate (DEC), ethyl methyl carbonate (EMC), dimethyl carbonate (DMC), propylene carbonate, or ethyl propionate. In some embodiments, the organic solvent includes an ether solvent, for example, at least one of 1,3-dioxolane (DOL) or ethylene glycol dimethyl ether (DME). In some embodiments, the lithium salt includes at least one of an organic lithium salt or an inorganic lithium salt. In some embodiments, the lithium salt includes but is not limited to lithium hexafluorophosphate (LiPF₆), lithium tetrafluoroborate (LiBF₄), lithium difluorophosphate (LiPO₂F₂), lithium bis(trifluoromethanesulfonyl)imide LiN(CF₃SO₂)₂(LiTFSI), lithium bis(fluorosulfonyl)imide Li(N(SO₂F)₂)(LiFSI), lithium bis(oxalato) borate LiB(C₂O₄)₂(LiBOB), or lithium difluoro (oxalato) borate LiBF₂(C₂O₄)(LiDFOB).

In some embodiments, the electrolyte contains fluoroethylene carbonate, and based on the mass of the electrolyte, a mass percentage of fluoroethylene carbonate is 11.5% to 19.5%. Including the foregoing electrolyte in the secondary battery can further stabilize the solid electrolyte interface film on the surface of the silicon-carbon composite material, helping improve the high-temperature cycling performance of the secondary battery.

### Positive Electrode Plate

The positive electrode plate includes a positive electrode current collector and a positive electrode active layer provided on the positive electrode current collector. The positive electrode current collector may be aluminum foil or nickel foil, or may be any composite current collector disclosed in the prior art, for example, but not limited to a current collector formed by combining the foregoing conductive foil with a polymer substrate. The positive electrode active layer includes a positive electrode active material, and the positive electrode active material includes a compound capable of reversibly intercalating and deintercalating lithium ions (that is, a lithiated intercalation compound). In some embodiments, the positive electrode active material may include a lithium transition metal composite oxide. The lithium transition metal composite oxide contains lithium and at least one element selected from cobalt, manganese, and nickel. In some embodiments, the positive electrode active material may include but is not limited to at least one of lithium cobalt oxide, nickel manganese cobalt oxide, nickel manganese aluminum oxide, lithium iron phosphate, lithium vanadium phosphate, lithium cobalt phosphate, lithium manganese phosphate, lithium manganese iron phosphate, lithium iron silicate, lithium vanadium silicate, lithium cobalt silicate, lithium manganese silicate, spinel lithium manganese oxide, spinel lithium nickel manganese oxide, or lithium titanate.

The positive electrode active layer further includes a binder for binding positive electrode active material particles to facilitate film layer formation and increase the binding force between the positive electrode active layer and the positive electrode current collector. In some embodiments, the binder may include but is not limited to at least one of polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, or nylon.

The positive electrode active layer may further include a conductive material, and the conductive material includes but is not limited to a carbon-based material, a metal-based material, a conductive polymer, or any combination thereof. In some embodiments, the carbon-based material may include but is not limited to natural graphite, artificial graphite, carbon black, acetylene black, Ketjen black, carbon fiber, or any combination thereof. In some embodiments, the metal-based material may include but is not limited to metal powder or metal fiber, such as copper, nickel, aluminum, or silver. In some embodiments, the conductive polymer may be a polyphenylene derivative.

The foregoing secondary battery is applied to an electronic apparatus to supply power to a load in the electronic apparatus. Moreover, when the proportions of crystalline silicon and amorphous silicon in the silicon-carbon composite material of the foregoing secondary battery are controlled within the appropriate ranges, the specific capacity of the secondary battery can be increased, thereby helping extend the service life of the electronic apparatus. The electronic apparatus may include but is not limited to a notebook computer, a pen-based computer, a mobile computer, an e-book reader, a portable telephone, a portable fax machine, a portable copier, a portable printer, a stereo headphone, a video recorder, a liquid crystal display television, a handheld cleaner, a portable CD player, a mini disc, a transceiver, an electronic notebook, a calculator, a memory card, a portable recorder, a radio, a backup power supply, a motor, an automobile, a motorcycle, a motorized bicycle, a bicycle, a lighting appliance, a toy, a game console, a clock, an electric power tool, a flash lamp, a camera, a large household battery, or a lithium-ion capacitor.

The following will describe this application with reference to specific examples and comparative examples. Those skilled in the art should understand that the preparation method described in this application is only an example, and all other suitable preparation methods shall fall within the scope of this application.

### Example 1-1

### Preparation of Silicon-Carbon Composite Material

100 g of porous carbon skeleton (that is, a porous carbon matrix with the pore volume percentage of mesopores being 40%) was heated to 450° C. at a rate of 10° C./min in a pure argon atmosphere.

Then, the pure argon atmosphere was changed to a silane gas mixture (20% monosilane and 80% argon by volume percentage), where the flow rate of the silane gas mixture was 200 sccm, and the porous carbon skeleton was deposited at 450° C. for 10 hours to obtain a first intermediate.

Pure argon was introduced into the first intermediate to evacuate the silane gas mixture, in a pure argon atmosphere, the temperature was raised from 450° C. to 700° C. at a rate of 5° C./min, and then another heating was performed since 700° C. for 6 hours to obtain a second intermediate.

The second intermediate was naturally cooled to 100° C. in a pure argon atmosphere, an oxygen gas mixture (10% oxygen and 90% nitrogen by volume percentage) was introduced, where the flow rate of the oxygen gas mixture was 200 sccm, and then the second intermediate was passivated in the oxygen gas mixture atmosphere for 2 hours to obtain the silicon-carbon composite material.

### Preparation of Half Lithium-Ion Button Cell

A mixture of graphite and the foregoing silicon-carbon composite material at a weight ratio of 90:10 was used as the negative electrode active material. The negative electrode active material, polymethyl acrylate, and sodium carboxymethyl cellulose were fully stirred and mixed in deionized water at a weight ratio of 97:2:1 to form a uniform negative electrode slurry, where a solid content of the negative electrode slurry was 40 wt %. This slurry was applied on a negative electrode current collector copper foil and dried at 85° C., followed by cold-pressing, cutting, slitting, and drying under vacuum at 120° C. for 12 hours, to obtain a negative electrode plate.

A solution containing LiPF₆, ethylene carbonate, and diethyl carbonate was uniformly mixed with fluoroethylene carbonate (FEC) and used as the electrolyte. Based on the mass of the electrolyte, a mass percentage of LiPF₆ was 12.5%, a mass percentage of FEC was 12%, and the remainder was ethylene carbonate and diethyl carbonate at a mass ratio of 1:1. A 7 μm polyethylene separator was used, a lithium sheet was used as the counter electrode, and a half button cell was assembled in a glove box.

### Preparation of Full Lithium-Ion Cell

Preparation of negative electrode plate: The negative electrode active material (a mixture of graphite and the foregoing silicon-carbon composite material at a weight ratio of 80:20), polymethyl acrylate, and sodium carboxymethyl cellulose were mixed at a weight ratio of 97:2:1, deionized water was added as a solvent to prepare a negative electrode slurry with a solid content of 40 wt %, and then the resulting mixture was stirred by a vacuum mixer to uniformity to obtain the negative electrode slurry. The negative electrode slurry was uniformly applied on one surface of a 12 μm-thick negative electrode current collector copper foil and dried at 85° C. to obtain a negative electrode plate with the negative electrode material layer coated on one surface, where the weight of the negative electrode material layer coating was 10 mg/cm². Then, the foregoing steps were repeated on another surface of the copper foil to obtain a negative electrode plate with the negative electrode material layer coated on both surfaces. A negative electrode plate of 78 mm×875 mm was obtained after cold pressing, cutting, slitting, drying under vacuum at 120° C. for 12 hours, and tab welding. After cold pressing, the compacted density of the negative electrode material layer was 1.7 g/cm³. The negative electrode active material included artificial graphite and the foregoing silicon-carbon composite material, and the mass ratio of artificial graphite to silicon-carbon composite particles was 80:20.

Preparation of positive electrode plate: The positive electrode active material lithium cobalt oxide, conductive carbon black Super P, and a positive electrode binder polyvinylidene fluoride (PVDF) were mixed at a mass ratio of 97:1.4:1.6, N-methylpyrrolidone (NMP) was added as a solvent to prepare a positive electrode slurry with a solid content of 72 wt %, and then the resulting mixture was stirred by a vacuum mixer to uniformity to obtain the positive electrode slurry. The positive electrode slurry was uniformly applied on one surface of a 12 μm-thick positive electrode current collector aluminum foil and dried at 85° C. to obtain a positive electrode plate with the positive electrode material layer coated on one surface, where the weight of the positive electrode material layer coating was 19 mg/cm². Then, the foregoing steps were repeated on another surface of the aluminum foil to obtain a positive electrode plate with the positive electrode material layer coated on both surfaces. A positive electrode plate of 74 mm×867 mm was obtained after cold pressing, cutting, slitting, drying under vacuum at 120° C. for 4 hours, and tab welding. After cold pressing, the compacted density of the positive electrode material layer was 4.2 g/cm³.

Preparation of electrolyte: In an argon atmosphere glove box with a water content of less than 10 ppm, fluoroethylene carbonate (FEC), ethylene carbonate (EC), and diethyl carbonate (DEC) were mixed uniformly to obtain a base solvent, and then a lithium salt lithium hexafluorophosphate (LiPF₆) was added to the base solvent and mixed to uniformity to obtain an electrolyte. Based on the mass of the electrolyte, a mass percentage of LiPF₆ was 12.5%, a mass percentage of FEC was 15%, and the remainder was EC and DEC, where the mass ratio of EC to DEC was 1:1.

Preparation of separator: A 7 μm-thick porous polyethylene membrane was used as the separator.

Preparation of lithium-ion battery: The positive electrode plate, the separator, and the negative electrode plate were stacked in sequence, with the separator located between the positive electrode plate and the negative electrode plate for isolation, and wound to obtain an electrode assembly. The electrode assembly was placed in an aluminum-plastic film packaging bag, dried at 80° C., injected with the electrolyte, and then subjected to processes including vacuum packaging, standing, formation, shaping, and capacity testing to obtain a pouch lithium-ion battery.

### Examples 1-2 to 1-14

Example 1-2 to Example 1-14 are the same as Example 1-1 except that: the temperature and/or duration for pyrolyzing the first intermediate are adjusted and relevant preparation parameters are adjusted according to Table 1.

### Examples 1-15 to 1-17

Example 1-15 to Example 1-17 are the same as Example 1-1 except that: the duration for pyrolyzing the first intermediate is adjusted, the pore volume percentage and average pore size of mesopores in the carbon matrix are changed, and relevant preparation parameters are adjusted according to Table 2.

### Examples 1-18 to 1-20

Example 1-18 to Example 1-20 are the same as Example 1-1 except that: the duration for silicon deposition after the silane gas mixture is introduced and the duration for pyrolyzing the first intermediate are adjusted, and relevant preparation parameters are adjusted according to Table 3.

### Examples 2-1 to 2-4

Example 2-1 to Example 2-4 differ from Example 1-1 in that: the proportions of components of the electrolyte are adjusted so that the proportion of FEC is as shown in Table 4, and the sum of the mass percentages of EC and DEC is adjusted according to the proportion of FEC. The mass ratio of EC to DEC remains unchanged.

### Comparative Examples 1 to 3

Comparative Example 1 to Comparative Example 3 are the same as Example 1-1 except that: the temperature for pyrolyzing the first intermediate is adjusted, and relevant preparation parameters are adjusted according to Table 1.

### Performance Testing Method for Silicon-Carbon Composite Material

### (1) Testing and Calculation of Alkali Solubility

10 g of potassium hydroxide and an appropriate amount of deionized water were put into a 500 ml volumetric flask for preparing an aqueous potassium hydroxide solution with a concentration of 1.78 mol/L. The mixture was stirred to uniformity to obtain the potassium hydroxide solution. 0.5 g of silicon-carbon composite material powder and 20 ml of the foregoing potassium hydroxide solution were added to an aluminum-plastic bag, and then the aluminum-plastic bag was sealed to be airtight. The rectangular aluminum-plastic bag was placed in a 50° C. constant temperature water bath and held for 6 hours. During the reaction, the volume change was recorded using the drainage method, and then the alkali solubility was calculated.

Alkali solubility calculation formula:

$$α = \frac{P \cdot Δ V / R \cdot T}{m \cdot {f}_{Si} / {M}_{Si}}$$

The total volume of the aluminum-plastic bag and water when immersed in the water bath at the beginning was recorded as V1, the total volume of the aluminum-plastic bag and water after 6 hours of immersion in the water bath was recorded as V2, and the change in system volume was recorded as ΔV, where ΔV=V2−V1. The ambient pressure (101.325 kPa) was recorded as P. The molar gas constant, which is 8.314 J (mol K)⁻¹, was recorded as R. The water bath temperature, which was 323 K, was recorded as T. The mass of the silicon-carbon composite material was recorded as m. The mass percentage of Si in the silicon-carbon composite material was recorded as f_{Si}. The molar mass of Si was recorded as M_{Si}.

### (2) Gas Generation Test of Powder

At 25° C., 0.5 g of silicon-carbon composite material powder and 4 g of deionized water were mixed and loaded into a 10 ml airtight bottle, the bottle was left standing for 48 hours at room temperature (25° C.), and then chemical gas chromatography analysis (Aglient 7890A, GC) was performed, to obtain the volume percentages of components of generated gas and H₂.

### (3) Raman Testing and Calculation

The silicon-carbon composite material was placed on a microscope slide for Raman testing, with a test range of 50 cm⁻¹ to 700 cm⁻¹. After testing, peak A of crystalline silicon (520 cm⁻¹±5 cm⁻¹) and peak B of amorphous silicon (480 cm⁻¹±5 cm⁻¹) between 50 cm⁻¹ and 700 cm⁻¹ were observed. Background subtraction was performed on the Raman spectrum using Origin, and then the ratio of peak A intensity I_{A} to peak B intensity I_{B} was calculated.

### (4) Test of Average Grain Diameter of Silicon in the Silicon-Carbon Composite Material

A D8 Advance instrument was used to test a Cu target (λ=1.54178 Å), tested at a voltage of 60 kV over an angle range of 2θ from 10° to 80°. Diffraction pattern analysis was performed using Highscore. After obtaining the XRD pattern of the silicon-carbon composite material, the average diameter of silicon grains in the silicon-carbon composite material was calculated at 2θ=28.4° using the Debye-Scherrer formula: D=Kλ/β cos θ, where K is the Scherrer constant, D is the diameter of silicon grains, β is the full width at half maximum of the diffraction peak of sample under test, θ is the Bragg diffraction angle, and A is the X-ray wavelength.

### (5) Mass Percentage Test of Element

The mass percentage of each element in the silicon-carbon composite material is determined by alkali etching, high-temperature oxidation, and thermogravimetric analysis. Specifically, 5 g of silicon-carbon composite material and 30 g of sodium hydroxide were added to a crucible. The crucible was heated to 400° C., held at this temperature for 1 hour, and then cooled to below 100° C. The reactant was put in deionized water at 80° C., washed multiple times with deionized water, filtered, and dried. The product was weighed, and its mass was recorded as ml, which was the mass of carbon. The filtrate was collected and subjected to ICP elemental testing to obtain the mass percentage of Si.

The proportion of oxygen element was measured using an oxygen-nitrogen-hydrogen analyzer.

### (6) Pore Volume/Pore Size Test

Silicon was removed from the silicon-carbon composite material by means of alkali dissolution. 5 g of silicon-carbon composite material and 30 g of sodium hydroxide were added to a crucible and mixed uniformly. The crucible was heated to 400° C. and then cooled to below 100° C. The reactant was put in 500 mL of deionized water at 80° C., washed, and filtered to obtain a solid product. The solid product was then added to a container containing 50 mL of hydrochloric acid and 450 mL of deionized water. The resulting mixture was ultrasonically treated for 10 minutes, washed with deionized water and suction-filtered to neutrality, and dried at 80° C. to obtain the carbon skeleton material (that is, the carbon matrix). The pore volume of the carbon skeleton material of the silicon-carbon negative electrode material was tested using the argon gas adsorption method. After adsorption/desorption data was obtained, pore structure fitting was performed using an NRDFT model to obtain the pore volume of pores of 0.5 nm to 10 nm and the pore volume of mesopores.

### (7) Gas Generation Test During Slurry Preparation

10 g of the negative electrode slurry used for preparing the full lithium-ion battery was placed in a 20 ml glass bottle. The glass bottle was sealed with a rubber ring and metal seal, shaken fully and sonicated for 5 minutes, and then left standing at room temperature (25° C.) for 48 hours. After that, chemical gas chromatography analysis (Aglient 7890A, GC) was performed to obtain the components and proportions of generated gases, then the volume percentage of hydrogen.

### Performance Test of Half Lithium-Ion Button Cell/Full Lithium-Ion Battery

### (1) Specific Capacity

The half button cell was discharged to 0.005 V at 0.05 C, 50 μA, and 10 μA respectively, and the first-cycle discharge capacity of the half button cell was recorded. Then, the half button cell was charged to 0.8 V at a constant current of 0.1 C, and the first-cycle charge capacity of the half button cell was recorded. First-cycle efficiency=first-cycle charge capacity/first-cycle discharge capacity×100%. First-cycle reversible specific capacity of the negative electrode active material between 0.005 V and 0.8 V=first-cycle charge capacity of the half button cell/mass of the negative electrode active material.

### (2) High-Temperature Cycling Test

The lithium-ion battery was placed in a 45° C. thermostat, charged to 4.4 V at a constant current of 1.5 C, charged to 0.05 C at a constant voltage of 4.4 V, and then discharged to 3.0 V at a constant current of 1.0 C. This was the first charge-discharge cycle. 300 charge-discharge cycles were performed in such manner, and the capacity retention rate was monitored. Capacity retention rate=remaining discharge capacity/first-cycle discharge capacity×100%.

The preparation conditions of all examples and comparative examples are recorded in Table 1 to Table 4. The secondary batteries assembled using the silicon-carbon composite materials prepared in Example 1-1 to Example 1-20, Example 2-1 to Example 2-4, and Comparative Example 1 to Comparative Example 3 are tested.

TABLE 1

| | Heat | Heat | | | | | | Volume | Gas | |
|---|---|---|---|---|---|---|---|---|---|---|
| | treatment | treatment | | | | | | percentage | generated | |
| | temperature | duration | | Mass | Mass | | | of H₂ in gas | during | |
| | for | for | Average | percentage | percentage | | | generated | preparation | |
| | pyrolyzing | pyrolyzing | diameter | of | of | | | by | of negative | |
| | the first | the first | of silicon | silicon | carbon | Value | Alkali | dispersion | electrode | Specific |
| | intermediate | intermediate | grains | element | element | of | solubility | system | slurry | capacity |
| | (° C.) | (h) | (nm) | (%) | (%) | I_{A}/I_{B} | α (%) | (%) | (%) | (mAh/g) |
| Example | 650 | 2 | 3.2 | 49.2 | 49.74 | 1.3 | 18.7 | 2.9 | 1.1 | 470 |
| 1-1 | | | | | | | | | | |
| Example | 650 | 2 | 3.0 | 46.1 | 52.31 | 1.3 | 18.9 | 3.4 | 1.3 | 465 |
| 1-2 | | | | | | | | | | |
| Example | 660 | 4 | 3.4 | 49.9 | 49.02 | 1.5 | 15.3 | 2.6 | 0.9 | 473 |
| 1-3 | | | | | | | | | | |
| Example | 670 | 5 | 3.4 | 49.4 | 49.57 | 1.8 | 10.2 | 2.3 | 0.8 | 474 |
| 1-4 | | | | | | | | | | |
| Example | 680 | 6 | 3.5 | 49.8 | 49.18 | 2.4 | 9.7 | 1.9 | 0.6 | 476 |
| 1-5 | | | | | | | | | | |
| Example | 690 | 6 | 3.6 | 49.7 | 49.28 | 3.3 | 6.8 | 1.5 | 0.4 | 477 |
| 1-6 | | | | | | | | | | |
| Example | 700 | 6 | 3.6 | 49.5 | 49.46 | 4.2 | 4.9 | 1.3 | 0.3 | 480 |
| 1-7 | | | | | | | | | | |
| Example | 740 | 6 | 4 | 49.1 | 49.88 | 5.2 | 0.3 | 0.5 | 0.1 | 482 |
| 1-8 | | | | | | | | | | |
| Example | 660 | 6 | 3.4 | 49.2 | 49.79 | 1.4 | 18.2 | 2.9 | 1.1 | 472 |
| 1-9 | | | | | | | | | | |
| Example | 710 | 6 | 3.6 | 49.7 | 49.27 | 4.2 | 4.5 | 1.3 | 0.3 | 480 |
| 1-10 | | | | | | | | | | |
| Example | 745 | 6 | 4.1 | 49.3 | 49.66 | 5.3 | 0.2 | 0.2 | 0.1 | 482 |
| 1-11 | | | | | | | | | | |
| Example | 655 | 6 | 3.4 | 49.7 | 49.21 | 1.4 | 18.5 | 2.9 | 1.1 | 471 |
| 1-12 | | | | | | | | | | |
| Example | 705 | 6 | 3.7 | 49.4 | 49.57 | 4.2 | 4.3 | 1.2 | 0.3 | 480 |
| 1-13 | | | | | | | | | | |
| Example | 750 | 6 | 4.2 | 49.1 | 49.83 | 5.3 | 0.1 | 0.2 | 0.1 | 483 |
| 1-14 | | | | | | | | | | |
| Comparative | 450 | 6 | 1.1 | 49.2 | 49.74 | 0.6 | 30 | 9.6 | 5.7 | 451 |
| Example 1 | | | | | | | | | | |
| Comparative | 500 | 6 | 1.3 | 49.8 | 49.12 | 0.8 | 24 | 7.7 | 4.4 | 453 |
| Example 2 | | | | | | | | | | |
| Comparative | 520 | 6 | 1.4 | 49.5 | 49.47 | 1 | 22 | 5.4 | 2.9 | 457 |
| Example 3 | | | | | | | | | | |

As shown in Table 1, compared with Comparative Example 1 to Comparative Example 3, in Example 1-1 to Example 1-8, when the Raman spectrum of the silicon-carbon composite material is within a specified range, gas generation during the preparation of the negative electrode slurry is reduced and the specific capacity of the silicon-carbon composite material is increased, so that the service life of the secondary battery is extended.

With reference to Example 1-9 to Example 1-14, when the alkali solubility of the silicon-carbon composite material is within an appropriate range, gas generation during the preparation of the negative electrode slurry is reduced and the specific capacity of the silicon-carbon composite material is increased.

TABLE 2

| | | | | | | | | | | Gas | |
|---|---|---|---|---|---|---|---|---|---|---|---|
| | Volume | Average | Heat | | | | | | Volume | generated | |
| | percentage | pore size | treatment | | | | | | percentage | during | |
| | of | of | duration for | Average | Mass | Mass | | | of H₂ | preparation | |
| | mesopores | mesopores | pyrolyzing | diameter | percentage | percentage | | | in gas | of negative | |
| | in carbon | in carbon | the first | of silicon | of silicon | of carbon | Value | Alkali | generated by | electrode | Specific |
| | matrix | matrix | intermediate | grains | element | element | of | solubility | dispersion | slurry | capacity |
| | (%) | (nm) | (h) | (nm) | (%) | (%) | I_{A}/I_{B} | α (%) | system (%) | (%) | (mAh/g) |
| Example | 65 | 8.2 | 6 | 7.8 | 47.2 | 51.73 | 1.3 | 9.8 | 1.8 | 0.5 | 476 |
| 1-15 | | | | | | | | | | | |
| Example | 52 | 6.1 | 6 | 5.9 | 48.4 | 50.54 | 1.3 | 13.5 | 2.1 | 0.8 | 478 |
| 1-16 | | | | | | | | | | | |
| Example | 40 | 5.4 | 1.5 | 3.1 | 49.3 | 49.69 | 1.4 | 18.2 | 2.8 | 1.1 | 481 |
| 1-17 | | | | | | | | | | | |

As shown in Table 2, in Example 1-15 to Example 1-17, when the average diameter of silicon grains in the nano-silicon particles is within a specified range, less gas is generated during the preparation of the negative electrode slurry containing the silicon-carbon composite material and the specific capacity of the silicon-carbon composite material is increased.

TABLE 3

| | | Heat | | | | | | | Gas generated | |
|---|---|---|---|---|---|---|---|---|---|---|
| | | treatment | | | | | | Volume | during | |
| | | duration for | Average | Mass | Mass | | | percentage of | preparation | |
| | Silicon | pyrolyzing | diameter | percentage | percentage | | | H₂ in gas | of negative | |
| | deposition | the first | of silicon | of silicon | of carbon | Value | Alkali | generated by | electrode | Specific |
| | duration | intermediate | grains | element | element | of | solubility | dispersion | slurry | capacity |
| | (h) | (h) | (nm) | (%) | (%) | I_{A}/I_{B} | α (%) | system (%) | (%) | (mAh/g) |
| Example | 8.5 | 6 | 3 | 42.3 | 56.69 | 1.3 | 5.3 | 0.2 | 0.3 | 470 |
| 1-18 | | | | | | | | | | |
| Example | 9.5 | 6 | 3.1 | 47.5 | 51.46 | 1.3 | 9.9 | 1.7 | 0.6 | 477 |
| 1-19 | | | | | | | | | | |
| Example | 10 | 6 | 3.3 | 49.8 | 49.15 | 1.3 | 18.5 | 2.8 | 1.1 | 481 |
| 1-20 | | | | | | | | | | |

As shown in Table 3, in Example 1-18 to Example 1-20, when the mass percentage of silicon element in the silicon-carbon composite material is within a specified range, less gas is generated during the preparation of the negative electrode slurry containing the silicon-carbon composite material and the specific capacity of the silicon-carbon composite material is increased.

TABLE 4

| | Mass percentage | High-temperature |
|---|---|---|
| | of fluoroethylene | cycling capacity |
| | carbonate (%) | retention rate (%) |
| Example 1-1 | 15 | 91.2% |
| Example 1-15 | 15 | 85.2% |
| Example 1-16 | 15 | 92.5% |
| Example 1-17 | 15 | 91.3% |
| Example 2-1 | 9 | 80.3% |
| Example 2-2 | 11.5 | 87.4% |
| Example 2-3 | 19.5 | 89.6% |
| Example 2-4 | 21 | 83.5% |

As shown in Table 4, compared with Example 1-1, in Example 2-1 to Example 2-4, the mass percentage of fluoroethylene carbonate in the electrolyte is adjusted. When the mass percentage of fluoroethylene carbonate in the electrolyte is within the range of 11.5% to 19.5%, the high-temperature cycling capacity retention rate of the secondary battery is further improved.

The foregoing descriptions are merely preferred embodiments of this application, and do not constitute limitation to this application. Any equivalent modifications to this application shall fall within the scope of this application.

What is claimed is:

1. A silicon-carbon composite material, comprising a carbon matrix and nano-silicon particles, wherein the nano-silicon particles are located within pores of the carbon matrix, and a Raman spectrum of the silicon-carbon composite material satisfies I_{A}≥1.2I_{B}, wherein I_{A} is a peak intensity of the Raman spectrum of the silicon-carbon composite material at 520 cm⁻¹±5 cm⁻¹, and I_{B} is a peak intensity of the Raman spectrum of the silicon-carbon composite material at 480 cm⁻¹±5 cm⁻¹.

2. The silicon-carbon composite material according to claim 1, wherein 5.3I_{B}≥I_{A}≥2.4I_{B}.

3. The silicon-carbon composite material according to claim 1, wherein an alkali solubility of the silicon-carbon composite material is α and α≤20%; wherein to measuring the alkali solubility of the silicon-carbon composite material includes mixing the silicon-carbon composite material and an aqueous potassium hydroxide solution to obtain a mixture, and keeping the mixture at the temperature of T1 for 6 hours and then subjected to an alkali solubility test, wherein 53° C.≥T1≥47° C., a concentration of the aqueous potassium hydroxide solution is 1.78 mol/L, and a mass ratio of potassium hydroxide to the silicon-carbon composite material in the mixture is 4:1.

4. The silicon-carbon composite material according to claim 3, wherein 0.1%≤α≤15%.

5. The silicon-carbon composite material according to claim 1, wherein in a dispersion system test of the negative electrode material, a gas generated from a dispersion system has a greater than 0.1% and less than 3% volume proportion of H₂ in the gas based on a total volume of the gas; the dispersion test includes: at the temperature T2, mixing the negative electrode material layer with water at a mass ratio of 1:8 to obtain the dispersion system, wherein 23° C.≤T2≤27° C., then the dispersion system is sealed and left standing for a duration time of 48 h, and then the gas generated from the dispersion system is tested to obtain the total volume of the gas and volume proportion of H₂ in the gas.

6. The silicon-carbon composite material according to claim 1, wherein the nano-silicon particles contain silicon grains, and an average diameter of the silicon grains is in the range of 3 nm to 8 nm.

7. The silicon-carbon composite material according to claim 6, wherein the average diameter of the silicon grains is in the range of 3 nm to 6 nm.

8. The silicon-carbon composite material according to claim 1, wherein the silicon-carbon composite material contains silicon element; and based on a mass of the silicon-carbon composite material, a mass percentage of the silicon element is 42% to 50%.

9. A method of preparing the silicon-carbon composite material according to claim 1, the method comprising:
(1) introducing a silane gas mixture into a carbon matrix and holding at a temperature in the range of 400° C. to 480° C. for a duration time in the range of 2 hours to 30 hours to obtain a first intermediate, wherein the silane gas mixture comprises silane gas and inert gas;
(2) in inert gas atmosphere, heat-treating the first intermediate at a temperature in the range of 650° C. to 750° C. for a duration time in the range of 1 hour to 6 hours to obtain a second intermediate; and
(3) at a temperature in the range of 25° C. to 200° C., introducing oxygen into the second intermediate to obtain the silicon-carbon composite material.

10. The preparation method according to claim 9, wherein the carbon matrix has mesopores, each mesopore is a pore with a pore size in the range of 2 nm to 10 nm; and based on a sum of pore volumes of pores with a pore size in the range of 0.5 nm to 10 nm, a pore volume percentage of the mesopores is in the range 40% to 70%.

11. A secondary battery, comprising a positive electrode plate, a separator, a negative electrode plate, and an electrolyte; wherein the negative electrode plate comprises a negative electrode current collector and a negative electrode material layer located on at least one surface of the negative electrode current collector, the negative electrode material layer comprises a negative electrode active material, and the negative electrode active material comprises graphite and a silicon-carbon composite material; wherein the silicon-carbon composite material comprises a carbon matrix and nano-silicon particles, wherein the nano-silicon particles are located within pores of the carbon matrix, and a Raman spectrum of the silicon-carbon composite material satisfies I_{A}≥1.2I_{B}, wherein I_{A} is a peak intensity of the Raman spectrum of the silicon-carbon composite material at 520 cm⁻¹±5 cm⁻¹, and I_{B} is a peak intensity of the Raman spectrum of the silicon-carbon composite material at 480 cm⁻¹±5 cm⁻¹;
and based on mass of the negative electrode active material, a mass percentage of the silicon-carbon composite material is 5% to 30%.

12. The secondary battery according to claim 11, wherein 5.3I_{B}≥I_{A}≥2.4I_{B}.

13. The secondary battery according to claim 11, wherein an alkali solubility of the silicon-carbon composite material is α and α≤20%; wherein to measuring the alkali solubility of the silicon-carbon composite material includes mixing the silicon-carbon composite material and an aqueous potassium hydroxide solution to obtain a mixture, and keeping the mixture at the temperature of T1 for 6 hours and then subjected to an alkali solubility test, wherein 53° C.≥T1≥47° C., a concentration of the aqueous potassium hydroxide solution is 1.78 mol/L, and a mass ratio of potassium hydroxide to the silicon-carbon composite material in the mixture is 4:1.

14. The secondary battery according to claim 13, wherein 0.1%≤α≤15%.

15. The secondary battery according to claim 11, wherein the nano-silicon particles contain silicon grains, wherein an average diameter of the silicon grains is in the range of 3 nm to 8 nm.

16. The secondary battery according to claim 15, wherein the average diameter of the silicon grains is in the range of 3 nm to 6 nm.

17. The secondary battery according to claim 11, wherein the electrolyte contains fluoroethylene carbonate; and based on mass of the electrolyte, a mass percentage of fluoroethylene carbonate is 11.5% to 19.5%.

18. An electronic apparatus, comprising the secondary battery wherein secondary battery comprises a positive electrode plate, a separator, a negative electrode plate, and an electrolyte, wherein the negative electrode plate comprises a negative electrode current collector and a negative electrode material layer located on at least one surface of the negative electrode current collector, the negative electrode material layer comprises a negative electrode active material, and the negative electrode active material comprises graphite and a silicon-carbon composite material; wherein the silicon-carbon composite material comprises a carbon matrix and nano-silicon particles, wherein the nano-silicon particles are located within pores of the carbon matrix, and a Raman spectrum of the silicon-carbon composite material satisfies I_{A}≥1.2I_{B}, wherein I_{A} is a peak intensity of the Raman spectrum of the silicon-carbon composite material at 520 cm⁻¹±5 cm⁻¹, and I_{B} is a peak intensity of the Raman spectrum of the silicon-carbon composite material at 480 cm⁻¹±5 cm⁻¹;
and based on mass of the negative electrode active material, a mass percentage of the silicon-carbon composite material is 5% to 30%.

19. The electronic apparatus according to claim 18, wherein 5.3I_{B}≥I_{A}≥2.4I_{B}.

20. The electronic apparatus according to claim 18, wherein the electrolyte contains fluoroethylene carbonate, and based on mass of the electrolyte, a mass percentage of fluoroethylene carbonate is 11.5% to 19.5%.
